(19) United States
(12) Patent Application Publication
(10) Pub. No.: US 2002/0125038 A1
(43) Pub. Date: Sep. 12, 2002

(54) Electrical power network

(76) Inventor: Bonnie Roche, New York, NY (US)

Correspondence Address: OSTROLENK FABER GERB & SOFFEN, 1180 AVENUE OF THE AMERICAS, NEW YORK, NY, 100368403

(21) Appl. No.: 10/091,159

(22) Filed: Mar. 5, 2002

Related U.S. Application Data
(60) Provisional application No. 60/273,968, filed on Mar. 6, 2001.

(51) Int. Cl. H01B 7/08

(52) U.S. Cl. 174/117 F

(57) ABSTRACT

An electrical network comprising: a first pin permeable insulating covering layer, a first electrically conductive layer disposed beneath the first covering material, a second insulating layer disposed beneath the first electrically conductive layer; and a second electrically conductive layer disposed beneath the second insulating layer, the first and second electrically conductive layers being insulated from each other by the second insulating layer and being adapted to be coupled to an electrical power source, the first and second insulating layers being permeable by an electrical connector device having at least one pin having contacts for contacting with respective ones of the first and second electrically conductive layers to supply power to an electrical device connected to the electrical pin device.

### CROSS REFERENCE TO RELATED APPLICATIONS

This application claims the benefit and priority of U.S. provisional patent application 60/273,968 filed Mar. 6, 2001, the entire disclosure of which is hereby incorporated by reference.

### BACKGROUND OF THE INVENTION

The present invention relates to a device for supplying electrical power, and more particularly, to an electrical powering network and device which can, for example, form a wall or be applied on or in a wall or other flat or curved surface or comprise a panel that is integral to or embedded within a substrate to provide electrical power to any points or a plurality of points on or in the device.

Applicant is aware of the following prior art: U.S. Pat. No. 4,744,766 to Hall et al.; U.S. Pat. No. 4,975,070 to Gillatt; U.S. Pat. No. 4,776,809 to Hall; U.S. Pat. No. 4,143,931 to Skare et al.; U.S. Pat. No. 3,341,803 to Bustamante; U.S. Pat. No. 2,481,181 to Walter; U.S. Pat. No. 2,361,721 to Deventer; U.S. Pat. No. 2,331,654 to Butler; U.S. Pat. No. 2,284,097 to LaJone, Sr. and U.S. Pat. No. 460,725 to Markle.

### SUMMARY OF THE INVENTION

The invention relates to an electrical power providing device which allows a user to connect an electrically powered device to the device of the invention, for example, connect a lighting fixture or electrical or electronic device, at any point or selected points on the electrical power providing device to obtain electric power. For example, the present invention can use a piercing pin or plug which can be inserted into the electrical power providing device at any point or at selected points to enable electrical power to be provided to an electrically powered device connected to the piercing pin or plug.

According to one aspect the invention comprises an electrical network comprising: a first pin permeable insulating covering layer, a first electrically conductive layer disposed beneath the first covering layer, a second insulating layer disposed beneath the first electrically conductive layer; and a second electrically conductive layer disposed beneath the second insulating layer, the first and second electrically conductive layers being insulated from each other by the second insulating layer and being adapted to be coupled to an electrical power source, the first and second insulating layers being permeable by an electrical connector device having one or more pins having contacts for contacting with respective ones of the first and second electrically conductive layers to supply power to an electrical device connected to the electrical pin device.

According to another aspect, the invention comprises an electrical network comprising: a substrate, a first electrical conductor arrangement disposed in the substrate, a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first and second electrical conductor arrangements are disposed beneath an insulating layer of the substrate.

According to yet another aspect, the invention comprises an electrical network comprising: a substrate, a first electrical conductor arrangement disposed in the substrate, a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first and second electrical conductor arrangements comprise electrically conductive layers comprising laminations of said substrate and wherein at least one of the layers and the portion of the substrate above the one of the layers is permeable by said plug device.

According to another aspect, the invention comprises an electrical network comprising: a substrate, a first electrical conductor arrangement disposed in or on the substrate, a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first electrical conductor arrangement is disposed as a top surface of said substrate.

### BRIEF DESCRIPTION OF THE DRAWINGS

Other features and advantages of the present invention will become apparent from the following description of the invention which refers to the accompanying drawings, in which:

FIG. 1 shows a perspective view of the device of the invention;

FIG. 2 shows an example of an electrically powered device that can be attached and powered by the electrical network of the invention;

FIG. 3 shows an electrical network device according to the present invention with an electrical connector attached;

FIGS. 3A and 3B show examples of electrical plugs having two pins for use with the invention;

FIG. 4 shows an example of the device of the invention wherein the device is configured as surfaces in a room of a building;

FIG. 5 shows another embodiment of the electrical network connection device according to the present invention;

FIG. 6 shows various pin embodiments according to the present invention; and

FIG. 7 shows various layer arrangements according to the present invention.

### DETAILED DESCRIPTION

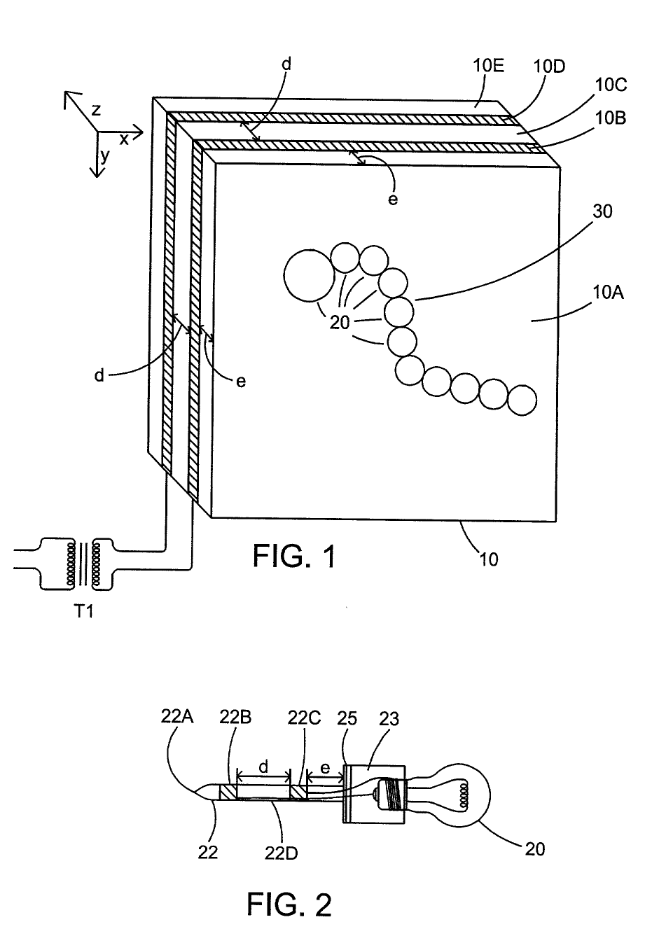

With reference to the drawing figures, FIG. 1 shows a perspective view of the device. The depth in the direction Z of the device has been enlarged to show clearly its structure. However, the device can be made thin so that it can be easily placed on or within a wall or curved surface to cover or become a flat or curved object. For example, the device may be a wall covering, wallpaper or panel or other surface covering or comprise the structure of the wall or object itself. Further, the device of the invention can also be a free standing self-supporting wall/structure or object. The device 10 comprises an insulating material which is permeable. The insulating material is laminated as follows: A covering insulating material layer 10A may be provided as the top surface. The covering surface 10A can have any ornamental or textured appearance as desired. For example the surface 10A may form the top surface of a bulletin board or display board or artistic display. Laminated to the layer 10A is a first electrically conductive layer 10B, followed by another insulating layer 10C followed again by a second electrically conductive layer 10D spaced from the layer 10B by a predetermined distanced determined by the layer 10C. Optionally, a final insulating layer 10E can be provided. Further, the layer 10A can be dispensed with, and the surface layer may comprise the conductive layer 10B.

The two layers 10B and 10D are connected to a suitable electrical power source, for example, and preferably, a low voltage power source provided, for example, by a step down isolating transformer T1 connected to the AC network. Alternatively, the transformer secondary may be coupled through a rectifier or rectifier/filter circuit to the device depending upon the devices being powered to provide DC current instead of AC current. Alternatively, a battery or other electrical power source can be connected to the conductive layers 10B and 10D.

Preferably, the device 10 is made so that it is suitably bendable so that it can bend around curves. It may also be made thin so that it can be disposed on a surface such as a wall surface as a wall covering. The device can also be made as a stand-alone bulletin or display board if desired or may be used as wall partitions, for example, to form modular living or office space. The device may also be used for ceilings or flooring. Further, the top layer 10A or any other layer may comprise or have an internal or external magnetic or magnetic attractive layer attached thereto or integrated therewith to allow either pushpins and/or magnetic attachment of objects to be displayed on the device 10. Any of the layers of device 10 can be composed of composite materials. Either of the conductive layers 10B and 10D can comprise a magnetic or magnet attractive layer. See for example, U.S. Pat. Nos. 5,295,342 and 5,384,999 in which a mesh is provided to allow magnet attraction and a permeable material is provided below the mesh to allow pushpin attachment.

FIG. 2 shows an example of an electrically powered device configured so it can be attached and powered by the device 10. The electrically powered device can be any electrically powered device. In FIG. 2 a lightbulb 20 is shown but any electrically powered device can be used, for example, a motor, a radio, computer, television or any other electrically powered device. Although the invention is shown as utilizing low voltage for safety, it should be appreciated that there is no reason why the invention could not also be used for higher voltages, for example, AC line voltages, although for safety reasons, this is not preferred.

In FIG. 2, a pin or plug 22 is provided for piercing into the surface of the device 10. The pin 22 has a sharp point 22A. Preferably, the pin 22 is made of an insulating material that contains two spaced contacts 22B and 22C separated by insulating material 22D. The contacts 22B and 22C are spaced apart approximately the same distance d (or somewhat less) separating the two conductive layers 10B and 10D and electrical connections are brought therefrom, similarly to a head phone jack, for example, to provide power to the electrically powered device. The contacts need only be spaced a distance d or so apart to assure proper electrical contact. For example, the centers of the contacts can be spaced a distance d apart, as will be appreciated by those of skill in the art. The actual spacing required will depend on factors such as the spacing between layers 10B and 10D and the thickness of these layers, etc., as will be appreciated by those of skill in the art.

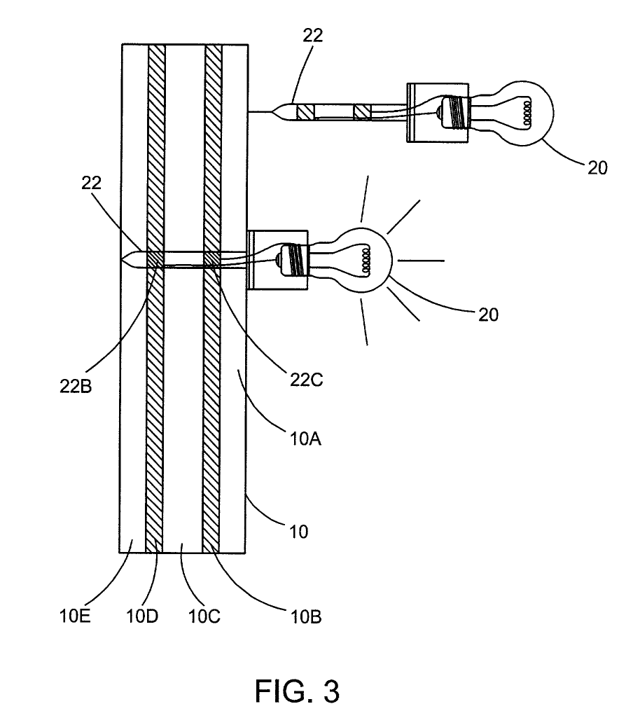

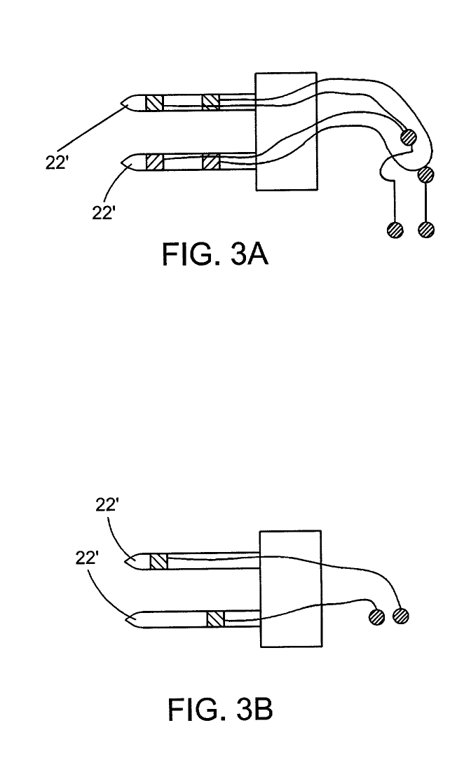

Other connection devices can be employed, for example, two side-by-side pins, one extending deeper than the other and having contacts thereon which are disposed so as to avoid short circuits as will be appreciated by those in the skill of design of electrical connectors. Still any other connection means can be used that suitably allows electrical contact with the two conductive layers. Further, the distance e from the distal end of the pushpin handle 23 to the proximal end of the contact 22C is spaced approximately corresponding to the same distance e from the surface of the device 10 to the first conductive layer 10B. See FIGS. 1 and 2. As shown in FIG. 3, the pin 22 is inserted into the permeable layer 10A, through the layers 10B, 10C and 10D and optionally into the layer 10E. The pin 22 can be made short so that it does not extend into layer 10E (if such layer is even provided). When the pin 22 is fully inserted, the contacts 22B and 22C will electrically conduct with the respective electrically conductive layers 10D and 10B thereby to provide power to the electrically powered device, in this case a lightbulb 20.

Although the electrically conductive layers 10B and 10D are shown as sheet layers, for example, metal sheets, they may also take other forms, for example, as wire mesh layers preferably of a wire mesh spacing so that the contacts 22B and 22C of the pin 22 will always conductively engage with the mesh. Alternatively, other forms can be use for the conductive layers 10B and 10D, for example, these layers or grids may form an electrically conductive particulate or powder or other conductive material. Further, the layers 10B and 10D need not be arranged at different depths. For example, the two layers can be provided at the same depth, alternatingly as strips, and a two prong connector device can be provided with each prong connecting to a respective one of the two strips. In addition, the layers discussed above need not be surface connection-oriented, but rather can be provided as point connections as well. The conductive layers can be arranged in any type of pattern that has regular or irregular characteristics, and can cover portions of the available surfaces.

Further, the invention is reversible. The device may be structured so that the pin 22 of FIG. 2 can be inserted from either side of the device 10. For example, this might be particularly useful for a shared partition for modular office furniture.

Further, either of the layers 10B and 10D can be magnetic or magnet attractive, thus providing a means for also magnetically securing objects thereto. In such case, it would be unnecessary to place another grid, mesh or layer on or in the device to provide this function.

Furthermore, although the electrically powered device 20 is shown as physically supported on the pin or plug 22, it need not be. It can also be located remotely from the pin 22 and merely connected to the pin 22 by electrical power wires.

Accordingly, the invention provides a device for the systematic attachment of electrically powered devices to any or selected points on the device of the invention. Preferably, the voltage is a low voltage for safety reasons. The invention can be used for providing lighting displays of various forms and taking various shapes (as shown generally and arbitrarily at 30 in FIG. 1) or for the electrical powering of any other electrically powered devices. Further, if the surface of the device 10 is provided with a ferromagnetic or magnetic material, the device can also be used for the display of magnetically attractive materials or to affix memos or notes using magnets and/or push pins. Further, such ferromagnetic or magnetic material can also serve as one conductor of the network. Further, the electrically powered device shown in FIG. 2 can also incorporate a magnet 25 so that the electrically powered device is held by the magnetic attraction of the magnet 25 to the surface 10A in addition to the frictional engagement of the pin 22 with the permeable material or other pins or attachment techniques on the device or on the surface or embedded in the composite material 10. Further, other means of attachment in addition to the pin 22 and/or magnet can also be employed, for example, a push pin or any other means of attachment.

The invention thus provides for great flexibility in attaching electrically powered devices to a display device. Lighting fixtures supported by the invention can be used to provide spot lighting, lighting of articles secured to the display device, task lighting on a horizontal surface or ceiling or floor perpendicular to a vertical surface of the display device or provide a wash of light over the display device. Other devices that can be powered by the invention include powered desk accessories, such as phones, computers, clocks, radios, TVs, calculators, chargers, etc. and without limitation. The device 10 need not be disposed vertically. It can be disposed in any orientation including horizontal. Further, the invention may be arranged such that the electrically conductive layers 10B and 10D form a grid or mesh providing electrical contact in a regular grid pattern or at predetermined locations allowing for predetermined locations for attachment of lighting or electrical devices in addition to the universal, “continuous-like” access to current provided by solid conductive layers. In such an arrangement using a mesh or grid, the top surface 10A may have a pattern formed thereon to define the locations (or layer 10B may be the top surface) where the electrically powered devices can be attached to the electrical supply. The invention thus provides for universal electrical access or “near” universal electrical access if a tight grid, lattice matrix, mesh, suspended particular, composite, etc. is employed for one or more of the conductive layers.

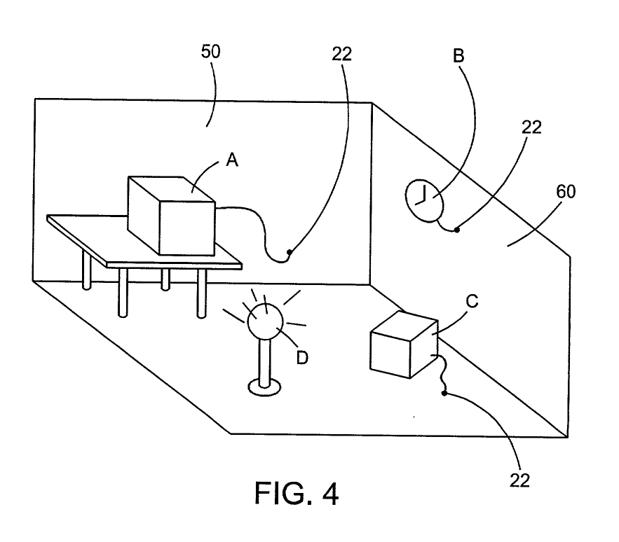

The invention provides a new way of providing power to electrical consumers in buildings. With the invention, it is no longer necessary to provide electrical receptacles at specified locations with the attendant wiring. The invention allows a consumer of electrical energy to plug an electrical device into the electrical supply at any location along a wall. See, for example, FIG. 4, which shows devices A, B and C plugged into walls 50 and 60 and floor 70 of a room at any location.

The invention is particularly useful for modular office units. The invention could also be implemented using wall board, commonly used to finish the interior walls of buildings. For example, gypsum wall board or any other insulating board or construction material could be provided with the conductive layers according to the invention. The wall boards can be installed in a building, and suitable electrical connections made, e.g., conductive connecting straps applied between wall board panels, to electrify a building. Preferably, the wall boards thus installed are connected to a source of low voltage electrical energy, either DC or AC. The invention is not limited to low voltage electrical power, but preferably is used with low voltage for safety reasons. In addition to providing safety, low voltage power also can reduce the size of many electrical and electronic devices, which typically employ a bulky power supply and transformer to step down the voltage from 120 or 240 V AC to low voltages, e.g. in the 3 to 36 volt range, without limitation. By employing the invention with a low voltage power source connected thereto, the size and weight of many electrical/electronic devices can be reduced, by elimination of the power supply or by reducing the size thereof, e.g. radios, televisions, computers, VCRs, DVD players, telephones, answering machines, etc.

To provide low voltage power, a central transformer or a number of transformers can be provided to step down the conventional higher voltage AC current available from typical electrical mains, typically 120 or 240 V AC. The low voltage output from the transformer(s) is then coupled to the device of the invention to provide power at any wall, floor and/or ceiling location throughout a building.

Further, the invention can be made so that the pin holes made by the pin/plug 22 are not visible. For example, suitable surface texturing, such as a textured paper, metallic mesh or cloth, on the exposed top surface can hide, eliminate or minimize any holes caused by insertion of pins 22. Further, the top surface can also be made of a suitable “self-healing” material which conceals, congeals, sets or flows to hide, cover, minimize or eliminate any holes caused by insertion of pins 22.

Further, the electrically conductive layers or electrodes need not be coextensive with the wall or panel areas. For example, the electrodes or electrically conductive layers may be confined to only certain regions of the overall panel area. As an example, the electrodes or electrically conductive layers may be disposed in a strip of a wall where electrical sockets would normally be disposed, i.e., the first two feet or so above the floor, as an example.

FIG. 3A shows an electrical plug for use with the invention having two pins 22; each having two electrical contacts for contacting the respective conductive layers. More pins can be provided, if desired. Further, it is not necessary that both pins have two contacts. One pin 22′ can have one contact for one conductive layer and the other pine 22′ can have a contact for the other layer. See FIG. 3B. In such case, the contact on each pin 22′ will be at a different depth.

As discussed, the conductive layer can be made of any conductive material, metal, foil, particulate, mesh or other wire apertured. A mesh is particularly useful as a conductive layer because it will guide the pin 22, 22′ through the aperture into the mesh easily. Further, a mesh provides shear strength to resist a variety of forces on the device 10, the pin 22 or powered electrical devices, attachments and so forth. The combination of the force provided by the mesh and the frictional force extend by the permeable insulating layers will assist in maintaining the pin 22 or pins 22′ in position in the device 10.

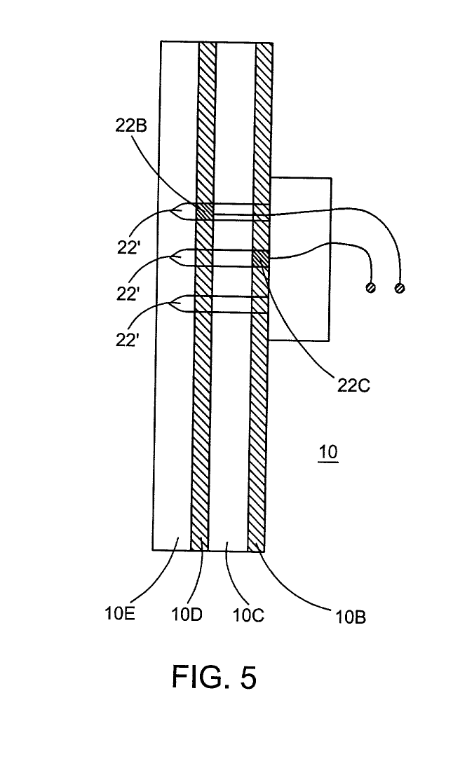

Referring now to FIG. 5, another embodiment of the device 10 is shown, in which layer 10B is exposed or otherwise uninsulated. This embodiment includes all the advantages of the device 10 shown in FIG. 3, so that plugs with pins are accepted without the need to orient the plug or select an opening for a plug pin 22′. The conductive layer 10B can be composed of a ferro-magnetic material to attract or repel magnets. In addition, several pins 22′ for the plug help to make the connection to device 10 more rigid. That is, with additional pins 22′, the plug can absorb greater shear forces without being detached from device 10. The pins 22′ may optionally be provided with connections 22B, 22C in this case on two or more of the pins 22′.

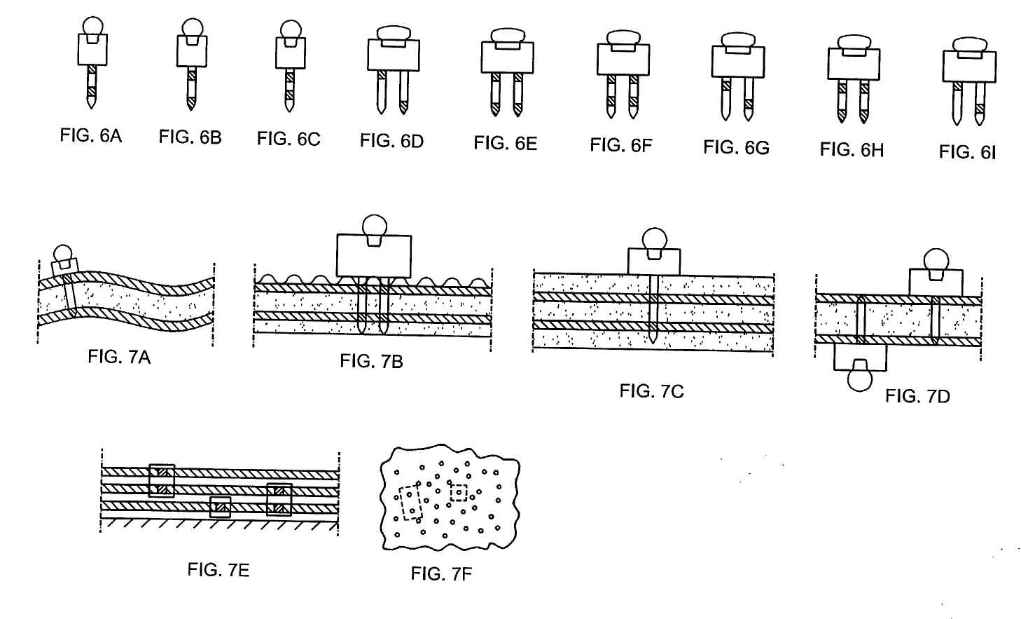

Referring now to FIG. 6, various pin and plug embodiments are shown. The various embodiments shows single and dual pin connectors, with electrical contacts located at various positions on the respective pin shafts. The location of electrical contacts on the pin shafts determine the connectivity of the pin shafts to various conductive layers based on the depth of pin penetration.

Referring now to FIG. 7, the device 10 is shown in various embodiments. FIG. 7A shows the device 10 with a curved, flexible profile to permit use in curved surface applications. FIG. 7D shows pin penetration from either side of the device 10. FIG. 7E illustrates the layer 10B composed of strips of conductive material to permit an electrical connection with pins shown in phantom. FIG. 7F shows the layer 10B with a point connection arrangement and connected pins in phantom.

Although the present invention has been described in relation to particular embodiments thereof, many other variations and modifications and other uses will become apparent to those skilled in the art. Therefore, the present invention should be limited not by the specific disclosure herein, but only by the appended claims.

What is claimed is:

1. An electrical network comprising:
a first pin permeable electrically conductive layer;
a second electrically conductive layer opposed to and spaced apart from said first layer;
the first and second electrically conductive layers being insulated from each other and being adapted to be coupled to an electrical power source; and
the first electrically conductive layer being permeable by an electrical connector device having at least one pin having contacts for contacting with respective ones of the first and second electrically conductive layers to supply power to an electrical device connected to the electrical pin device.

2. An electrical network comprising:
a first pin permeable insulating covering layer;
a first electrically conductive layer disposed beneath the first covering layer;
a second insulating layer disposed beneath the first electrically conductive layer; and
a second electrically conductive layer disposed beneath the second insulating layer, the first and second electrically conductive layers being insulated from each other by the second insulating layer and being adapted to be coupled to an electrical power source, the first and second insulating layers being permeable by an electrical connector device having at least one pin having contacts for contacting with respective ones of the first and second electrically conductive layers to supply power to an electrical device connected to the electrical pin device.

3. The electrical network of claim 2, wherein at least one of the first and second electrically conductive layers comprise sheet metal layers permeable to said pin device.

4. The electrical network of claim 2, wherein at least one of the first and second electrically conductive layers comprises a metal apertured grid or mesh.

5. The electrical network of claim 2, wherein the electrical connector device comprises a needle like device having a shaft and contacts arranged on the shaft at respective locations defined by distances from the outer layer of the first insulating material to locations in the electrical network where the respective first and second electrically conductive layers are located.

6. The electrical network of claim 2, wherein the electrical connector devices comprises a plurality of needle-like devices each having a shaft for making electrical contact with at least one of the conductive layers.

7. The electrical network of claim 2, wherein the electrical power source comprises one of an AC power source and a DC power source.

8. The electrical network of claim 2, wherein the electrical power source includes an electrical transformer.

9. The electrical network of claim 2, wherein the electrical network comprises a wall, floor or ceiling of a room of a building structure.

10. The electrical network of claim 2, further comprising a third insulating layer disposed beneath the second electrically conductive layer.

11. The electrical network of claim 2, wherein the first insulating layer has a decorative surface.

12. The electrical network of claim 2, wherein the electrical network comprises one of a wallcovering and display panel.

13. The electrical network of claim 2, wherein at least one of the two electrically conductive layers is magnet attractive or magnetic to enable attachment thereto of magnetic or magnet attractive devices.

14. The electrical network of claim 2, further comprising a magnet attractive or magnetic layer to enable attachment thereto of magnetic or magnet attractive device.

15. The electrical network of claim 2, wherein the electrical network comprises one of a device disposable on a wall of a building structure and a free standing device.

16. The electrical network of claim 2, wherein the electrical network comprises a bulletin board.

17. The electrical network of claim 2, wherein the electrical network comprises a modular wall partition.

18. The electrical network of claim 2, wherein the electrical network is at least one of curved and bendable.

19. The electrical network of claim 2, wherein the electrical network is reversible so that the pin device can be inserted in a reverse direction.

20. The electrical network of claim 2, wherein at least one of the first and second conductive layers comprises a conductive particulate or powder.

21. The electrical network of claim 2, wherein the pin device or electrically powered device comprises a magnet or magnet attractive material to provide magnetic coupling of the pin device or electrically powered device to the electrical network.

22. The electrical network of claim 2, wherein the electrically conductive layers are arranged as a strip.

23. An electrical network comprising:
a substrate;
a first electrical conductor arrangement disposed in the substrate;
a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first and second electrical conductor arrangements are disposed beneath an insulating layer of the substrate.

24. The electrical network of claim 23, wherein the first and second electrical conductor arrangements each comprise sheet metal layers permeable to said plug device.

25. The electrical network of claim 23, wherein at least one of the first and second electrical conductor arrangements comprises a metal apertured grid or mesh.

26. The electrical network of claim 23, wherein the plug device comprises a needle like device having a shaft and contacts arranged on the shaft at respective locations defined by distances from the outer layer of the substrate to the location in the substrate where the respective first and second electrical conductor arrangements are located.

27. The electrical network of claim 23, wherein the plug device comprises a plurality of needle-like devices each having a shaft for making electrical contact with at least one of the conductor arrangements.

28. The electrical network of claim 23, wherein the electrical power source comprises one of an AC power source, and a DC power source.

29. The electrical network of claim 23, wherein the electrical power source includes an electrical transformer.

30. The electrical network of claim 23, wherein the electrical network comprises a wall, floor or ceiling of a room of a building structure.

31. The electrical network of claim 23, wherein substrate comprises a laminated structure, with said first and second electrical conductor arrangements comprising laminations of said laminated structure.

32. The electrical network of claim 23, wherein the first insulating layer has a decorative surface.

33. The electrical network of claim 23, wherein the electrical network comprises one of a wallcovering and display panel.

34. The electrical network of claim 23, wherein at least one of the two electrical conductor arrangements is magnet attractive or magnetic o enable attachment thereto of magnetic or magnet attractive devices.

35. The electrical network of claim 23, further comprising a magnet attractive or magnetic layer to enable attachment thereto of magnetic or magnet attractive devices

36. The electrical network of claim 23, wherein the electrical network comprises one of a device disposable on a wall of a building structure and a free standing device.

37. The electrical network of claim 23, wherein the electrical network comprises a bulletin board.

38. The electrical network of claim 23, wherein the electrical network comprises a modular wall partition.

39. The electrical network of claim 23, wherein the electrical network is at least one of curved and bendable.

40. The electrical network of claim 23, wherein the electrical network is reversible so that the plug device can be inserted in a reverse direction.

41. The electrical network of claim 23, wherein the first and second conductive layers comprise a conductive particulate or powder.

42. The electrical network of claim 23, wherein the plug device or electrically powered device comprises a magnet or magnet attractive material to provide magnetic coupling of the pin device or electrically powered device to the electrical network.

43. The electrical network of claim 23, wherein the electrical conductor arrangements are arranged as at least one of strip-like structures and point structures.

44. The electrical network of claim 23, wherein the electrical conductor arrangements are arranged as at least one of a strip and a point.

45. An electrical network comprising:
a substrate;
a first electrical conductor arrangement disposed in the substrate;
a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first and second electrical conductor arrangements comprise electrically conductive layers comprising laminations of said substrate and wherein at least one of the layers and the portion of the substrate above the one of the layers is permeable by said plug device.

46. An electrical network comprising:
a substrate;
a first electrical conductor arrangement disposed in or on the substrate;
a second electrical conductor arrangement disposed in the substrate electrically insulated from the first electrical conductor arrangement, the first and second electrical conductor arrangements being adapted to be coupled to an electrical power source, the first and second electrical conductor arrangements being connectable to an electrical plug device having contacts for contacting with respective ones of the first and second electrical conductor arrangements to supply power to an electrical device connected to the electrical plug device; further wherein the first electrical conductor arrangement is disposed as a top surface of said substrate.

47. An electrical network comprising:
a pin permeable substrate;
a first electrical conductor arrangement disposed on a surface of the substrate;
a second electrical conductor arrangement disposed on an opposing substrate surface and electrically insulated from the first electrical conductor arrangement;
the first and second electrical conductor arrangements being adapted to be coupled to an electrical power source; and
the first and second electrical conductor arrangements being connectable to an electrical plug device having contacts for contacting with respective ones of the first and second electrical conductor arrangements to supply power to an electrical device connected to the electrical plug device.

48. The electrical network of claim 47, wherein at least one of said first and second electrical conductor arrangements is a metallic mesh.

49. The electrical network of claim 48, wherein the mesh is woven.

50. The electrical network of claim 48, wherein the mesh is randomly bundled metallic fibers.

51. The electrical network of claim 48, wherein the mesh provides a self-guiding mechanism for insertion of the electrical plug device.

52. The electrical network of claim 47, wherein at least of said first and second electrical conductor arrangements is a composite material conductor.
